(19) United States
(12) Patent Application Publication
(10) Pub. No.: US 2026/0142070 A1
(43) Pub. Date: May 21, 2026

(54) INDUCTOR

(71) Applicant: Murata Manufacturing Co., Ltd., Kyoto-fu (JP)

(72) Inventor: Kenichi HARADA, Nagaokakyo-shi (JP)

(73) Assignee: Murata Manufacturing Co., Ltd., Kyoto-fu (JP)

(21) Appl. No.: 19/450,401

(22) Filed: Jan. 15, 2026

Related U.S. Application Data
(63) Continuation of application No. PCT/JP2024/018711, filed on May 21, 2024.

(30) Foreign Application Priority Data
Aug. 24, 2023 (JP) 2023-136388

(51) Int. Cl. H01F 27/28; H01F 27/00; H01F 27/255; H01F 27/29; H01F 27/34

(52) U.S. Cl. CPC H01F 27/2852; H01F 27/006; H01F 27/255; H01F 27/292; H01F 27/34

(57) ABSTRACT

An inductor having good electrical characteristics with a reduced DC resistance regardless of the size of a section of a coil conductor. The inductor includes a coil conductor including a wound portion and a pair of extended portions, the wound portion being formed by winding a rectangular conducting wire whose section orthogonal to a longitudinal direction of the conducting wire has a substantially rectangular shape, and the extended portions being extended from the wound portion; a body containing magnetic powder and a resin and containing the coil conductor; and outer electrodes formed on a surface of the body and connected to the respective extended portions. The body has two main surfaces that face each other and that cross a winding axis of the wound portion of the coil conductor. The extended portions each include an extended region extending from the wound portion to one of the main surfaces.

### CROSS-REFERENCE TO RELATED APPLICATIONS

This application claims benefit of priority to International Patent Application No. PCT/JP2024/018711, filed May 21, 2024, and to Japanese Patent Application No. 2023-136388, filed Aug. 24, 2023, the entire contents of each are incorporated herein by reference.

### BACKGROUND

### Technical Field

The present disclosure relates to an inductor.

### Background Art

Japanese Unexamined Patent Application Publication No. 2019-4174 discloses a coil component including a body in which a core containing magnetic particles contains a wound conducting wire, and a pair of outer electrodes provided on a surface of the body. In the coil component, end surfaces of two end portions of the wound conducting wire in the length direction are connected to the respective outer electrodes.

### SUMMARY

In the coil component having the above configuration, the end surfaces of the wound conducting wire are connected to the respective outer electrodes. Accordingly, the contact area between each outer electrode and the conducting wire is limited to the size of a section of the conducting wire, thus limiting the DC resistance of the coil component.

Therefore, the present disclosure provides an inductor that includes a body in which a core containing magnetic particles contains a wound conducting wire, and a pair of outer electrodes provided on the body and that has good electrical characteristics with a reduced DC resistance regardless of the size of a section of the conducting wire.

An inductor according to an aspect of the present disclosure includes: a coil conductor including a wound portion and a pair of extended portions, the wound portion being formed by winding a rectangular conducting wire whose section orthogonal to a longitudinal direction of the conducting wire has a substantially rectangular shape, and the extended portions being extended from the wound portion; a body containing magnetic powder and a resin and containing the coil conductor; and outer electrodes formed on a surface of the body and connected to the respective extended portions. The body has two main surfaces that face each other and that cross a winding axis of the wound portion of the coil conductor. The extended portions each include an extended region extending from the wound portion to one of the main surfaces of the body, and an electrode connection region connected to a corresponding one of the outer electrodes. In the electrode connection region, a side surface along a short side of the rectangular shape formed by the section orthogonal to the longitudinal direction of the conducting wire is exposed along the one of the main surfaces of the body, and the conductor of the conducting wire is connected to the outer electrode.

The present disclosure can provide an inductor having good electrical characteristics with a reduced DC resistance regardless of the size of a section of a coil conductor.

### BRIEF DESCRIPTION OF THE DRAWINGS

FIG. 1 is a perspective view of an inductor according to an embodiment of the present disclosure when viewed from the upper surface side of a body;

FIG. 2 is a perspective view of the inductor when viewed from the bottom surface side of the body;

FIG. 3 is a transparent perspective view illustrating the internal configuration of the inductor;

FIG. 4 is a schematic view of the manufacturing process of the inductor;

FIG. 5 is a transparent view of the inductor when viewed in a direction perpendicular to the bottom surface of the body;

FIG. 6 is a transparent view of the inductor when viewed in a direction perpendicular to an end surface of the body;

FIG. 7 is a diagram illustrating the relationship between the extended angle θ of an extended portion extended from a wound portion and the evaluation index Ei of electrical characteristics; and

FIG. 8 is a diagram illustrating the relationship between the ratio Ra of the length of an electrode connection region to the length of the extended portion and the evaluation index Ei.

### DETAILED DESCRIPTION

The configuration and a manufacturing method of an inductor 1 according to an embodiment will be described below.

### [1. Overall Configuration of Inductor]

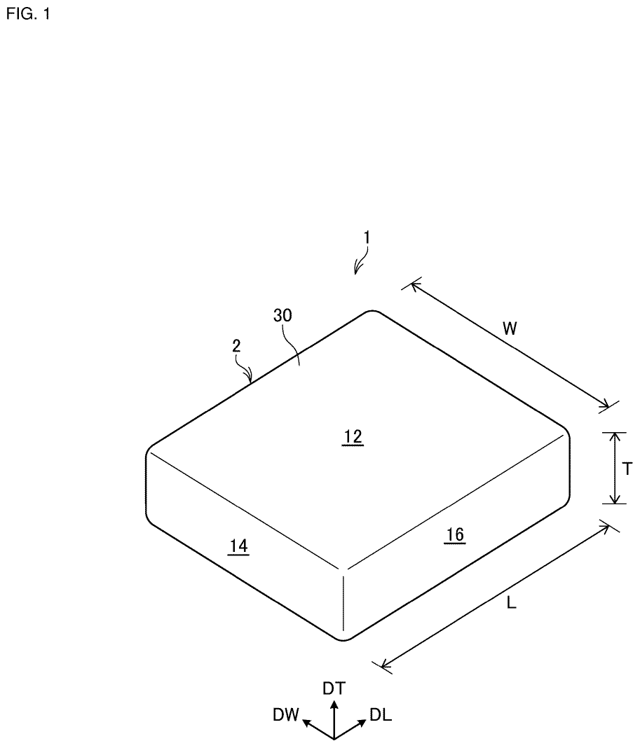

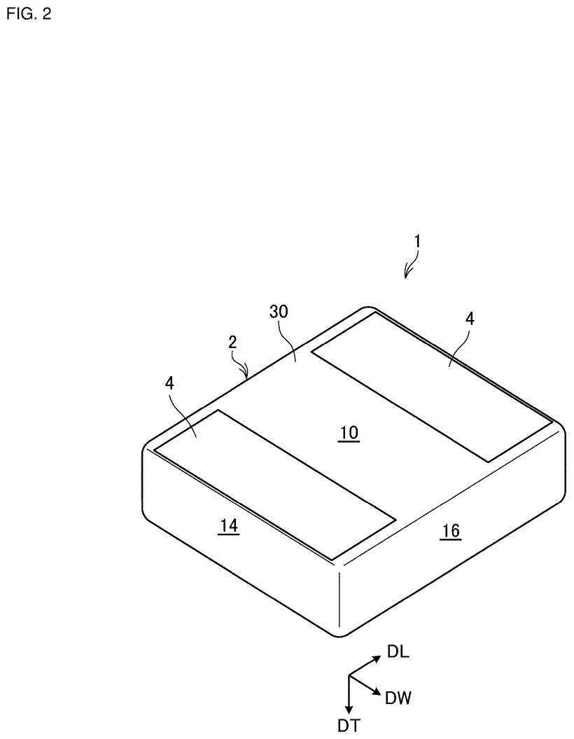

FIG. 1 is a perspective view of the inductor 1 according to the present embodiment when viewed from the upper surface 12 side. FIG. 2 is a perspective view of the inductor 1 when viewed from the bottom surface 10 side. The bottom surface 10 and the upper surface 12 are two main surfaces of a body 2 facing each other.

The inductor 1 according to the present embodiment is formed as a surface-mount electronic component and includes the body 2 having a substantially cuboid shape, which is a form of substantially hexahedral shape, and a pair of outer electrodes 4 provided on a surface of the body 2.

Hereinafter, one main surface of the body 2, which is a mounting surface facing a mounting substrate (not illustrated) when being mounted, is defined as the bottom surface 10, and the other main surface of the body 2 facing the bottom surface 10 is referred to as the upper surface 12. In addition, a pair of outer surfaces of the body 2 orthogonal to the bottom surface 10 are referred to as end surfaces 14, and a pair of outer surfaces of the body 2 orthogonal to the bottom surface 10 and the pair of end surfaces 14 are referred to as side surfaces 16. The pair of end surfaces 14 are disposed so as to face each other. In addition, the pair of side surfaces 16 are disposed so as to face each other. The bottom surface 10, the upper surface 12, the end surfaces 14, and the side surfaces 16 have respective substantially rectangular shapes.

As illustrated in FIG. 1, the distance from the bottom surface 10 to the upper surface 12 is defined as the thickness T of the body 2, the distance between the pair of side surfaces 16 is defined as the width W of the body 2, and the distance between the pair of end surfaces 14 is defined as the length L of the body 2. In addition, the direction of the thickness Tis defined as a thickness direction DT, the direction of the width W is defined as a width direction DW, and the direction of the length L is defined as a length direction DL. That is, the bottom surface 10 and the upper surface 12 are parallel to the width direction DW and the length direction DL, the end surfaces 14 are parallel to the width direction DW and the thickness direction DT, and the side surfaces 16 are parallel to the length direction DL and the thickness direction DT. In addition, the end surfaces 14 are adjacent to the bottom surface 10, the upper surface 12, and the pair of side surfaces 16. The side surfaces 16 are adjacent to the bottom surface 10, the upper surface 12, and the pair of end surfaces 14.

As the nominal size of the inductor 1 as a completed product, for example, the length Lis 1.4 mm, the width W is 1.2 mm, and the thickness T is 0.65 mm.

Hereinafter, a plane parallel to the direction DL and the direction DT is referred to as an LT plane, a plane parallel to the direction DT and the direction DW is referred to as a TW plane, and a plane parallel to the direction DL and the direction DW is referred to as an LW plane. In addition, respective sections of the inductor 1 parallel to the LT plane, the TW plane, and the LW plane are referred to as an LT section, a TW section, and an LW section.

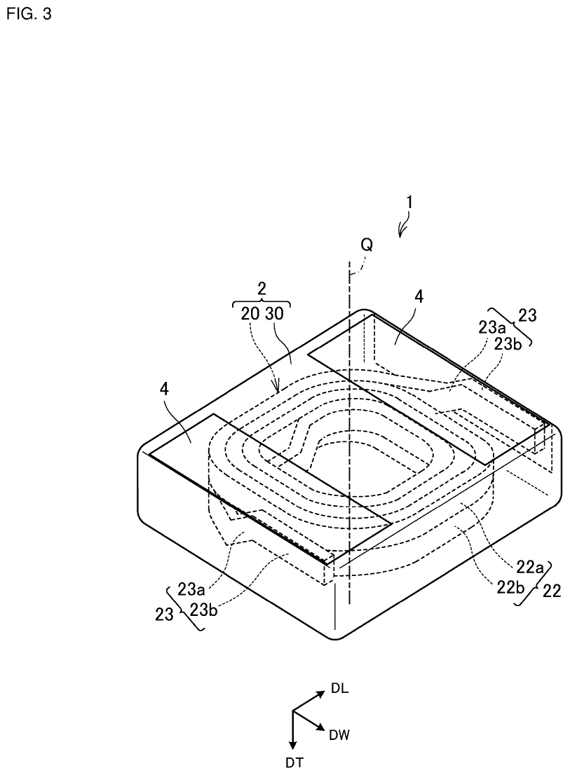

FIG. 3 is a transparent perspective view illustrating the internal configuration of the inductor 1.

The body 2 includes a coil conductor 20 and a core 30, in which the coil conductor 20 is embedded and which has a substantially hexahedral shape, and is formed as a molded inductor in which the coil conductor 20 is sealed in the core 30.

The core 30 is a compressed molded body formed by pressing and heating mixed powder that is a mixture of magnetic particles (magnetic powder) and a resin in the state in which the mixed powder contains the coil conductor 20 to form a substantially hexahedral shape.

In addition, the magnetic particles according to the present embodiment are made of a soft magnetic material and include particles having two kinds of particle size, that is, a first magnetic particles, which are large particles whose average particle size is relatively large, and a second magnetic particles, which are small particles whose average particle size is relatively small. Thus, together with the resin, the second magnetic particles, which are small particles, enter between the first magnetic particles, which are large particles, during compression molding. Accordingly, it is possible to increase the filling rate of the magnetic particles in the core 30 and to increase the magnetic permeability.

In the present embodiment, the average particle size of metal particles of the first magnetic particles is 20 μm or more and 28 μm or less (i.e., from 20 μm to 28 μm), and the average particle size of metal particles of the second magnetic particles is 1 μm or more and 6 μm or less (i.e., from 1 μm to 6 μm). The average particle size of the first magnetic particles is preferably 21.4 μm or more and 27.4 μm or less (i.e., from 21.4 μm to 27.4 μm). The average particle size of the second magnetic particles is preferably 1.5 μm or more and 1.8 μm or less (i.e., from 1.5 μm to 1.8 μm). In addition, the magnetic particles may include particles having three or more kinds of particle size by including particles whose average particle size is different from the respective average particle sizes of the first magnetic particles and the second magnetic particles.

Each of the first magnetic particles and the second magnetic particles is a particle including a metal particle, an oxide film covering a surface of the metal particle, and an insulating film covering a surface of the oxide film. Covering the metal particle with the oxide film and the insulating film enables an increase in insulation resistance and dielectric strength.

Fe—Si—B amorphous alloy powder is used for the metal particles of the first magnetic particles according to the present embodiment. The oxide film of each of the first magnetic particles is formed by two layers, that is, a SiO layer and an Fe₂SiO₄ layer. The thickness of the entire oxide film is 20 nm or more and 155 nm or less (i.e., from 20 nm to 155 nm). In addition, the insulating film of each of the first magnetic particles is made of phosphate glass having a thickness of 10 nm or more and 50 nm or less (i.e., from 10 nm to 50 nm). In addition, carbonyl iron powder is used for the metal particles of the second magnetic particles according to the present embodiment. The oxide film of each of the second magnetic particles is made of iron oxide formed by subjecting carbonyl iron powder, which is formed by metal particles, to surface oxidation. In addition, the insulating film of each of the second magnetic particles is a product of the sol-gel process using silica. Thus, it is possible to improve the slipperiness of the surface of the second magnetic particle and to thus facilitate entrance of the second magnetic particles between the first magnetic particles during a body molding and curing step of the body 2, which will be described later. As a result, it is possible to further increase the density of the magnetic material in the core 30 and to thus further increase the relative permeability of the core 30.

Fe—Si—Cr alloy powder, Fe—Ni—Al alloy powder, Fe—Cr—Al alloy powder, Fe—Si—Al alloy powder, Fe—Ni alloy powder, or Fe—Ni—Mo alloy powder may be used for the metal particles of the first magnetic particles.

In addition, phosphoric acid, zinc phosphate, manganese phosphate, glass, or resin may be used for the insulating film of each of the first magnetic particles.

The resin material contained in the mixed powder according to the present embodiment contains bisphenol A epoxy resin and rubber-modified epoxy resin. Thus, it is possible to manufacture the inductor 1 including the body 2 having both increased strength and increased toughness.

In the present embodiment, in the magnetic powder contained in the mixed powder, the content of the first magnetic particles is 70 wt % or more and 85 wt % or less (i.e., from 70 wt % to 85 wt %) and the content of the second magnetic particles is 15 wt % or more and 30 wt % or less (i.e., from 15 wt % to 30 wt %) relative to the total weight of the magnetic particles contained in the mixed powder. In addition, the content of the resin contained in the mixed powder is 2.0 wt % or more and 3.5 wt % or less (i.e., from 2.0 wt % to 3.5 wt %) relative to the total weight of the magnetic powder and the resin. The content of the first magnetic particles is preferably 70 wt % or more and 80 wt % or less (i.e., from 70 wt % to 80 wt %). The content of the second magnetic particles is preferably 20 wt % or more and 30 wt % or less (i.e., from 20 wt % to 30 wt %). In addition, the content of the resin is preferably 2.7 wt % or more and 30 wt % or less (i.e., from 2.7 wt % to 30 wt %).

As illustrated in FIG. 3, the coil conductor 20 includes a wound portion 22 formed by winding a conducting wire around a winding axis Q, and a pair of extended portions 23 extended from the wound portion 22. The wound portion 22 is formed by winding the conducting wire into two layers along the winding axis Q, that is, upper and lower layers to form a spiral shape and includes two wound regions 22a and 22b overlapping along the winding axis Q. An inner circumferential conducting wire portion of the wound region 22a and an inner circumferential conducting wire portion of the wound region 22b are continuous with each other. Each end of the conducting wire forms the extended portion 23 by being extended from an outer circumferential portion of the wound portion 22. Each extended portion 23 includes an extended region 23a, which extends from the wound portion 22 to the bottom surface 10 of the body 2, and an electrode connection region 23b, which is the part of the conducting wire connected to the outer electrode 4 described later. Respective bent portions are included between the wound portion 22 and the extended region 23a and between the extended region 23a and the electrode connection region 23b.

The coil conductor 20 is embedded in the body 2 such that the winding axis Q of the wound portion 22 is parallel to the thickness direction DT of the body 2. That is, the winding axis Q is orthogonal to the bottom surface 10 and the upper surface 12 and extends in the direction along the end surfaces 14 and the side surfaces 16.

The conducting wire forming the coil conductor 20 includes a conductor and a cover layer formed on a surface of the conductor. The conducting wire is a rectangular conducting wire whose section orthogonal to the longitudinal direction of the conducting wire has a rectangular shape and has a wide surface formed by a side surface along a long side of the rectangular section. The conducting wire is wound such that the wide surface is parallel to the winding axis Q. The conductor is a belt-shaped conductor whose section has a rectangular shape and that is made of copper. The thickness of the conductor is 52 μm or more and 118 μm or less (i.e., from 52 μm to 118 μm). The width of the conductor is 110 μm or more and 180 μm or less (i.e., from 110 μm to 180 μm). The cover layer includes an insulating layer formed on a surface of the belt-shaped conducting wire, and a fusion layer for adhering parts of the belt-shaped conducting wire of the wound portion 22 overlapping each other to each other, the fusion layer being formed on a surface of the insulating layer. The insulating layer is made of, for example, polyimide amide resin and has a thickness of 3 μm. In addition, the fusion layer is made of, for example, polyamide resin and has a thickness of 1 μm or more and 25 μm or less (i.e., from 1 μm to 25 μm).

The two extended portions 23 are extended from the wound portion 22 to the bottom surface 10 of the body 2 and are electrically connected to the respective outer electrodes 4 via the respective electrode connection regions 23b exposed to the bottom surface 10 of the body 2.

The pair of outer electrodes 4 are formed on the bottom surface 10 of the body 2. The outer electrodes 4 are not limited to having this configuration and each may be a so-called L-shaped electrode formed by an L-shaped member extending from the bottom surface 10 to the adjacent end surface 14. Alternatively, the outer electrodes 4 each may be a five-surface electrode extending from the bottom surface 10 to the upper surface 12 through the adjacent end surface 14 and side surfaces 16.

The outer electrodes 4 are each electrically connected to a wiring line of a circuit board by an appropriate mounting means such as soldering. As described later, in the specific configuration of the inductor 1, in the present embodiment, a side surface along a short side of a rectangular shape formed by a section of the conducting wire that is the coil conductor 20 orthogonal to the longitudinal direction is exposed from the body 2, and the conductor of the conducting wire is connected to the outer electrode 4.

In addition, a body protective layer (not illustrated) is formed on the part of the surfaces of the body 2 excluding the region of each outer electrode 4. The body protective layer is made of, for example, a resin material made by adding phenoxy resin to novolac resin and contains nanosilica as a filler. The body protective layer is formed on the surfaces of the body 2 so as to have a thickness of 10 μm or more and 30 μm or less (i.e., from 10 μm to 30 μm). The thickness of the body protective layer is preferably 10 μm or more and 20 μm or less (i.e., from 10 μm to 20 μm), more preferably, 15 μm or less.

The inductor 1 having this configuration can be improved in DC bias characteristic by using a soft magnetic material for magnetic particles and is thus usable as an electronic component of an electric circuit through which a large current flows and a choke coil of a DC-DC converter circuit or a power supply circuit. In addition, the inductor 1 is usable as an electronic component of an electronic device such as a personal computer, a DVD player, a digital camera, a TV, a cellular phone, a smartphone, automotive electronics, a medical machine, or an industrial machine. However, the inductor 1 is not limited to having these uses and is also usable for, for example, a tuning circuit, a filter circuit, or a rectification smoothing circuit.

### [2. Outline of Manufacturing Process of Inductor]

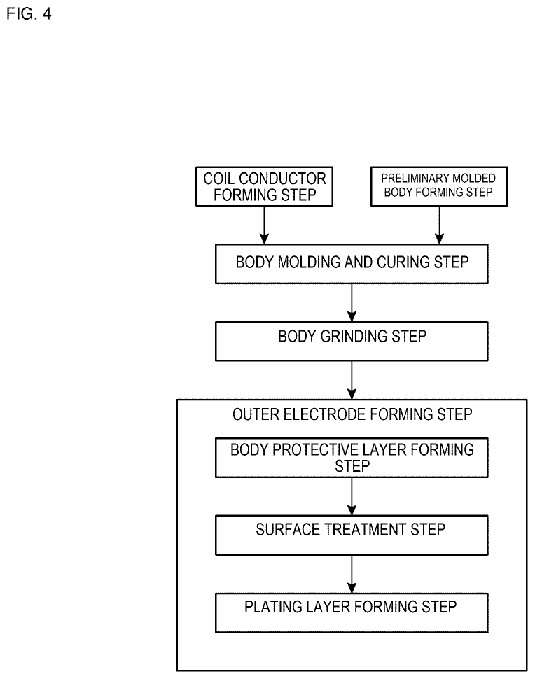

FIG. 4 is a schematic view of the manufacturing process of the inductor 1.

As illustrated in FIG. 4, the manufacturing process of the inductor 1 includes a coil conductor forming step, a preliminary molded body forming step, the body molding and curing step, a body grinding step, and an outer electrode forming step.

The coil conductor forming step is a step of forming the coil conductor 20 from a conducting wire. In this step, the coil conductor 20 is shaped so as to include the wound portion 22 and the extended portions 23 described above by winding the conducting wire by a winding method that is called “alpha winding”. The alpha winding is a winding method by which the conducting wire functioning as a conductor is wound into two layers to form a spiral shape such that the extended portions 23 in the first and last winding turns of the conducting wire are located at the outer circumference. The number of turns of the coil conductor 20 is not particularly limited.

The preliminary molded body forming step is a step of forming preliminary molded bodies that are called tablets.

The preliminary molded bodies are solid molded bodies that are easy to handle formed by pressing the above mixed powder, which is a material for the body 2. In the present embodiment, two kinds of tablets are formed as follows: a first tablet, on which the coil conductor 20 is disposed and which has an appropriate shape (for example, an E shape or a T shape), and a second tablet having an appropriate shape (for example, an I shape or a plate-like shape), the coil conductor 20 being sandwiched between the first tablet and the second tablet.

In the body molding and curing step, the first tablet, the coil conductor, and the second tablet are set on molding dies, pressed in the direction in which the first tablet and the second tablet overlap each other while being heated, and cured. Thus, the first tablet, the coil conductor, and the second tablet are integrated with each other. Accordingly, the body 2, in which the core 30 contains the coil conductor 20, is molded. In addition, barreling may be performed on the body 2 formed in this step to remove, for example, burrs formed on the body 2 and to chamfer the edges of the body 2.

The body grinding step is a step of grinding the side surfaces 16 of the body 2 to adjust the width W of the body 2. In the body grinding step, the body 2 is sandwiched from above and below by upper and lower whetstones of a grinding machine in the state of being held by a plate-like member that is called a holding plate. In this state, the side surfaces of the body 2 are ground by operating the grinding machine so as to rotate the upper and lower whetstones.

The outer electrode forming step is a step of forming the outer electrodes 4 on the body 2 and includes a body protective layer forming step, a surface treatment step, and a plating layer forming step.

The body protective layer forming step is a step of coating the entire surfaces of the body 2 with an insulating resin.

The surface treatment step is a step of irradiating electrode formation regions of the surface of the core 30 with laser light to reform the surfaces of the electrode formation regions. Here, the electrode formation regions are the regions of the surface of the core 30 where the outer electrodes 4 are to be formed and include the parts where the electrode connection regions 23b are exposed. Specifically, the irradiation of the electrode formation regions with laser light removes the parts of the body protective layer of the surface of the body 2 in the electrode formation regions and the cover layers of the electrode connection regions 23b of the coil conductor 20 and removes the resin on the surface of the core 30 and the insulating films on the surfaces of the magnetic particles exposed from the core 30 in the electrode formation regions. Thus, the parts of the surface of the core 30 in the electrode formation regions have a larger area where the metal of the magnetic particles is exposed per unit area of the surface of the core 30 than the other part of the surface of the core 30. After the laser light irradiation, a cleaning treatment (for example, an etching treatment) may be performed to clean the surfaces of the electrode formation regions.

In the plating layer forming step, the surface of the core 30 is subjected to copper barrel plating to form copper plating layers on the electrode formation regions irradiated with laser light. In addition, a Ni plating layer and a Sn plating layer may be formed on each copper plating layer.

### [3. Specific Configuration of Inductor]

Details of the inductor 1 according to the present embodiment will be further described below.

As described above, in the coil component according to the Japanese Unexamined Patent Application Publication No. 2019-4174, the tip end surfaces of the conducting wire forming a coil conductor are connected to the respective outer electrodes. In the existing coil component having the above configuration, the contact area between each outer electrode and the coil conductor is limited to the size of the end surface of the coil conductor, thus limiting the DC resistance of the coil component.

On the other hand, in the inductor 1 according to the present embodiment, the extended portions 23 extended from the wound portion 22 in a direction toward the bottom surface 10 of the body 2 include the respective electrode connection regions 23b, where parts of the side surface of the conducting wire are exposed to the bottom surface 10. Then, the exposed parts of the side surface of the conducting wire in the electrode connection regions 23b are connected to the respective outer electrodes 4. Thus, in the inductor 1, it is possible to increase the contact area between the outer electrode 4 and the electrode connection region 23b regardless of the size of the tip end surface of the conducting wire. Accordingly, it is possible to reduce the DC resistance of the inductor 1 compared with the related art and to thus achieve good characteristics.

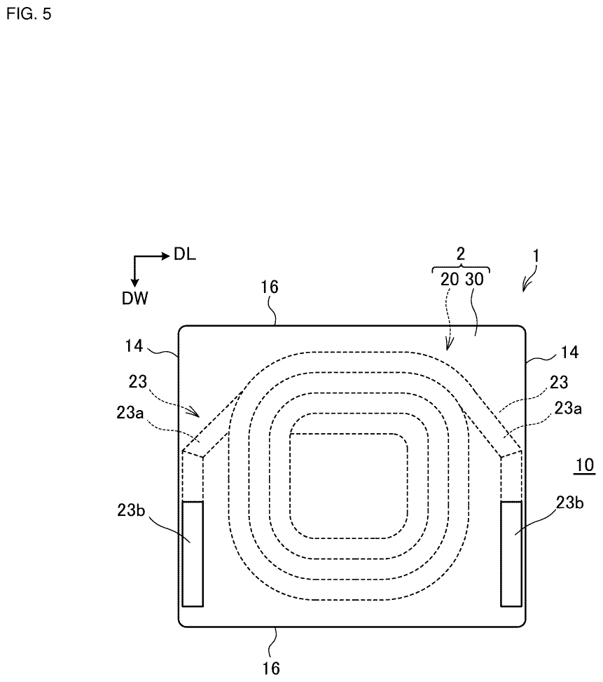

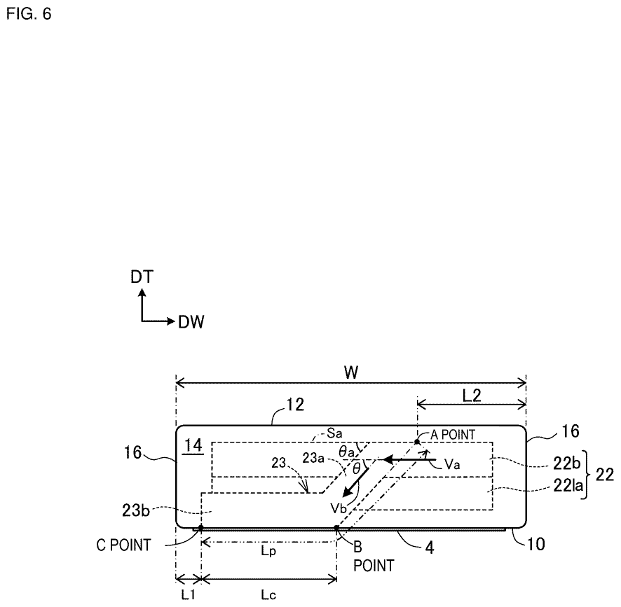

FIG. 5 is a plan view of the inductor 1 illustrated in FIG. 3 when viewed from the bottom surface 10 side. FIG. 6 is a side view of the inductor 1 illustrated in FIG. 5 when viewed from the end surface 14, on the left side in FIG. 5, side and illustrates an example of the configuration of the extended portion 23 extended from the wound region 22a on the upper surface 12 side. To facilitate understanding, FIG. 5 is simplified by omitting the outer electrodes 4.

As illustrated in FIGS. 3, 5, and 6, the respective electrode connection regions 23b of the pair of extended portions 23 are exposed from the bottom surface 10 and are connected to the corresponding outer electrodes 4.

As illustrated in FIG. 6, the outermost circumferential conducting wire portion of the wound region 22b is bent in the direction toward the bottom surface 10, and the extended portion 23 continuous from the wound region 22b thus includes the extended region 23a extended from the wound portion 22. Then, the part of the side surface of the rectangular conducting wire forming the extended portion 23 is exposed from the bottom surface 10 and is bent so as to extend along the bottom surface 10. Thus, the part of the extended portion 23 extended to the bottom surface 10 forms the one electrode connection region 23b.

On the side of the other end surface 14 facing the end surface 14 illustrated in FIG. 6, similarly to the above configuration, the outermost circumferential conducting wire portion of the wound region 22a is bent in the direction toward the bottom surface 10, and the other extended portion 23 continuous from the wound region 22a thus includes the extended region 23a extended from the wound portion 22. Then, the part of the side surface of the rectangular conducting wire forming the extended portion 23 is exposed from the bottom surface 10 and is bent so as to extend along the bottom surface 10. Thus, the part of the extended portion 23 extended to the bottom surface 10 forms the other electrode connection region 23b.

In the present embodiment, as illustrated in FIG. 3, the side surface of the electrode connection region 23b exposed from the bottom surface 10 and connected to the outer electrode 4 is a side surface along a short side of a rectangular shape formed by a section of the rectangular conducting wire forming the extended portion 23 orthogonal to the longitudinal direction.

The configuration illustrated in FIG. 3 eliminates the need for twisting a conducting wire when producing a coil having a flatwise winding structure such as the wound portion 22 and thus has an advantage in simplifying the manufacturing process. In addition, the configuration illustrated in FIG. 3 enables a magnetic flux generated in the wound portion 22 along the winding axis Q to be inhibited from being blocked by the parts of the conducting wire of the extended portions 23 compared with the configuration in which a side surface (that is, a wide surface) along a long side of a rectangular shape formed by a section of the conducting wire orthogonal to the longitudinal direction is connected to the outer electrode 4. As a result, the inductor 1 is capable of achieving good inductance characteristics.

### [4. Evaluation of Electrical Characteristics of Inductor]

In the inductor 1 configured as described above, the DC resistance of the part where the electrode connection region 23b and the outer electrode 4 are connected to each other reduces with increasing the length of the electrode connection region 23b extending along and exposed from the bottom surface 10. However, an increase in the length of the electrode connection region 23b may affect other electrical characteristics of the inductor 1 such as inductance and DC bias current due to, for example, a reduction in the volume of the core 30 containing the magnetic material and forming the body 2.

Thus, the inventors of the present disclosure investigated the relationship between the configuration of the extended portions 23 including the electrode connection regions 23b and the electrical characteristics of the inductor 1 by using simulation. With reference to FIG. 6, as parameters affecting the electrical characteristics of the inductor 1, the inventors particularly focused on the extended angle θ, which is the angle formed by the extension direction in which the outermost circumferential conducting wire portion of the wound portion 22 extends toward the extended portion 23 and the extension direction of the extended region 23a of the extended portion 23 extended from the wound portion 22 to the bottom surface 10, and focused on the ratio Ra (=Lc/Lp) of the length Lc of the electrode connection region 23b to the length Lp of the extended portion 23.

For example, the extended angle θ is defined as the bent angle formed by the first extension direction Va, in which the outermost circumferential conducting wire portion of the wound portion 22 extends toward the extended portion 23, and the second extension direction Vb, which is the extension direction of the extended region 23a of the extended portion 23 bent from the first extension direction Va and extended in the direction toward the bottom surface 10. For example, the extended angle θ can be measured as the angle (θa illustrated in FIG. 6) formed by the surface Sa, which is formed by the contour of the wound portion 22 and which is closer to the upper surface 12 of the body 2, and the side surface, closer to the upper surface 12 of the body 2, of the part of the conducting wire forming the extended region 23a of the extended portion 23.

In addition, for example, the length Lp of the extended portion 23 is defined as the length from the A point, which is the intersection point of the surface Sa of the wound portion 22 and a line segment extending in the extension direction of the side surface of the extended region 23a closer to the bottom surface 10, to the C point, which is the end point of the extended portion 23 on the bottom surface 10, through the B point, which is located at the position on the bottom surface 10 where the extended region 23a and the electrode connection region 23b are connected to each other. In addition, for example, the length Lc of the electrode connection region 23b can be defined as the length of the part of the extended portion 23 exposed from the bottom surface 10, the length being measured along the side surface of the extended portion 23 closer to the bottom surface 10 (that is, the length from the B point to the C point).

The index Ei calculated by using the following equation (1) was used as an evaluation index indicating the evaluation of electrical characteristics.

$$Ei = Li \times Isat / Rdc \qquad ( 1 )$$

In the above equation (1), Li, Isat, and Rdc are the inductance, the DC bias current, and the DC resistance of the inductor 1, respectively.

The index Ei increases with improving electrical characteristics. That is, the index Ei increases with increasing the inductance Li, with increasing the DC bias current Isat, or with reducing the DC resistance Rdc.

### [4.1 Production of Sample]

To evaluate the electrical characteristics of the inductor 1, the inventors produced one body 2 and calculated the index Ei by using varied extended angles θ and ratios Ra in a simulation based on the produced body 2.

The body 2 used in the simulation was produced as follows.

A mixture of Fe—Si—Cr alloy powder as first magnetic particles and carbonyl iron powder as second magnetic particles was used as metal magnetic powder of mixed powder that is a material for a core 30. According to the results measured by a particle size analyzer, in the metal magnetic powder in the example, the average particle size of the first magnetic particles was 25.3 μm, and the average particle size of the second magnetic particles was 1.7 μm. In addition, a resin material in the example contains bisphenol A epoxy resin and rubber-modified epoxy resin, and the content thereof in the mixed powder was 2.7 wt %. According to the results measured by the inventors, the mixed powder had a relative permeability of 34 and a saturation magnetic flux density of 1.36 T. The relative permeability was measured by using a BH analyzer and an impedance/material analyzer with a high-frequency signal having a frequency of 1 MHz. In addition, the saturation magnetic flux density was the saturation magnetic flux density of the mixed powder measured such that a change in inductance at the time of biasing was measured by using an LCR meter and a DC power supply and the saturation magnetic flux density was measured by reverse calculation based on the BH data when the magnetic flux saturated.

A conducting wire used for a coil conductor 20 was a rectangular conducting wire whose section orthogonal to the longitudinal direction of the conducting wire had a substantially rectangular shape. The longitudinal length and the lateral length of the rectangular section were 0.128 mm and 0.083 mm, respectively. The coil conductor 20 was shaped so as to include a wound portion 22 including two layers and formed by alpha winding, and extended portions 23. The wound portion 22 was formed by winding the conducting wire by alpha winding into two layers along a winding axis Q, that is, upper and lower layers to form a spiral shape and included two wound regions 22a and 22b overlapping along the winding axis Q. The extended angle θ of each extended portion 23 extended from the outer circumferential portion of the wound portion 22 was 90 degrees.

The body 2 was produced by using the core 30 and the coil conductor 20 described above. The coil conductor 20 had an orientation in which the winding axis Q of the wound portion 22 is substantially perpendicular to the bottom surface 10, which is a mounting surface of the body 2.

The distance L1 (see FIG. 6) from the end position (the position of the C point) of an electrode connection region 23b of the extended portion 23 to the side surface 16 of the body 2 closest to the C point was 100 μm. The reason why the end position of the electrode connection region 23b was the above position was as follows. When the end position is closer to the side surface 16 than this position, the wall thickness of the side surface 16 in this part is thin, thus easily causing body cracking or chipping. As a result, the mechanical strength of the body 2 cannot reach the practical level.

The distance L2 (see FIG. 6) from the A point, which was the starting point of the extended portion 23, to the side surface 16 facing the side surface 16 closest to the end position of the electrode connection region 23b was W/3.

### [4.2 Evaluation Results]

First, the relationship between the extended angle θ and the index Ei was evaluated.

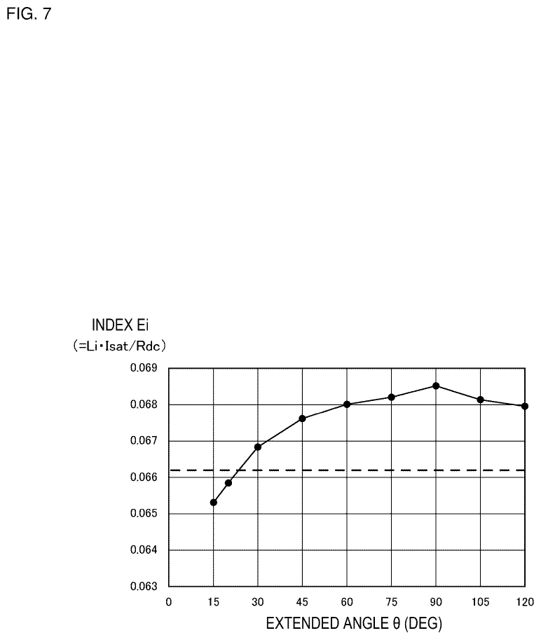

FIG. 7 illustrates simulation results of the index Ei relative to the extended angle θ. In FIG. 7, the horizontal axis represents the extended angle θ, and the vertical axis represents the index Ei. In the calculation, similarly to the above sample, the distance L1 and the distance L2 were 100 μm and W/3, respectively.

As illustrated in FIG. 7, the index Ei increases with increasing the extended angle θ within the range in which the extended angle θ is 90 degrees or less. Then, the index Ei reaches a peak when the extended angle θ is 90 degrees and reduces as the extended angle θ is larger than 90 degrees. Here, the reason why the index Ei increases within the range in which the extended angle θ is 90 degrees or less is because the length of the electrode connection region 23b increases with increasing the extended angle θ, thus reducing the DC resistance Rdc.

In addition, the reason why the index Ei reduces within the range in which the extended angle θ is larger than 90 degrees is as follows. When the extended angle θ is larger than 90 degrees, the extended portion is wound so as to return from the direction in which the wound portion is wound, and the direction of a current flowing in the extended portion 23 is thus opposite to the direction of a current flowing in the part of the conducting wire of the wound portion 22 continuous with the extended portion. In addition, an increase in the length of the electrode connection region 23b reduces the volume of the core 30 containing the magnetic material of the body 2, thus reducing the inductance Li and the DC bias current Isat.

Accordingly, from the results illustrated in FIG. 7, the extended angle θ is preferably 90 degrees or less.

In addition, for example, assuming that the inductor 1 is used for a power inductor of a DC-DC converter circuit required to have a particularly small DC resistance and a particularly large DC bias current, the index Ei is preferably 0.0662 (the level represented by a broken line in FIG. 7) or more from the viewpoint of maintaining the power efficiency of the DC-DC converter circuit to the practical level.

Accordingly, as is clear from FIG. 7, the extended angle θ is more preferably 30 degrees or more and 90 degrees or less (i.e., from preferably 30 degrees to 90 degrees).

Next, the relationship between the index Ei and the ratio Ra of the length Lc of the electrode connection region 23b to the length Lp of the extended portion 23 was evaluated. Table 1 shows simulation results of the index Ei when the ratio Ra was varied while the extended angle θ was fixed. In the simulation in Table 1, the ratio Ra was varied by increasing the distance L2 from W/3 (that is, shifting the starting point A to the left side in FIG. 6) to vary the length Lc of the electrode connection region 23b while the extended angle θ and the distance L1 were respectively fixed at 90 degrees and 100 μm similarly to the above sample.

In addition, Table 2 shows simulation results of the index Ei when the extended angle θ was varied while the distance L1 and the distance L2 were fixed. In the simulation in Table 2, similarly to the above sample, the distance L1 and the distance L2 were 100 μm and W/3, respectively.

TABLE 1

| | | | | | | | | | |
|---|---|---|---|---|---|---|---|---|---|
| Ratio Ra | 0.15 | 0.22 | 0.25 | 0.29 | 0.36 | 0.42 | 0.49 | 0.56 | 0.58 |
| Index Ei | 0.0651 | 0.0657 | 0.0662 | 0.0663 | 0.0668 | 0.0673 | 0.0678 | 0.0683 | 0.0685 |

TABLE 2

| Ratio Ra | 0.25 | 0.33 | 0.42 | 0.49 | 0.58 |
|---|---|---|---|---|---|
| Index Ei | 0.0668 | 0.0676 | 0.0680 | 0.0682 | 0.0685 |

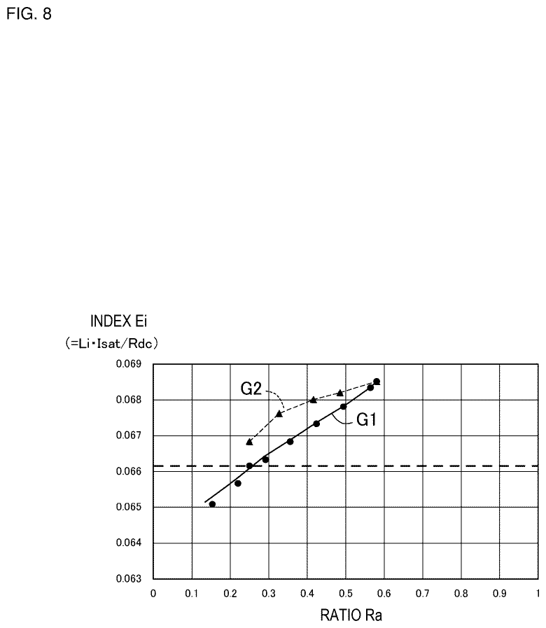

FIG. 8 is a diagram in which the relationship between the ratio Ra and the index Ei is plotted from the results shown in Table 1 and Table 2. In FIG. 8, the horizontal axis represents the ratio Ra, and the vertical axis represents the index Ei. In addition, in FIG. 8, graphs G1 and G2 are graphs formed by plotting the results shown in Table 1 and Table 2, respectively.

In FIG. 8, the state in which the ratio Ra represented by the horizontal axis is 0.58 corresponds to the state in which the extended angle θ, the distance L1, and the distance L2 are 90 degrees, 100 μm, and W/3, respectively, similarly to the above sample.

In addition, in FIG. 8, similarly to FIG. 7, a broken line represents the lower limit of the index Ei of 0.0662 assuming that the inductor 1 is used for a power inductor of a DC-DC converter circuit.

In the case of each of the graphs G1 and G2, the length of the electrode connection region 23b increases with increasing the ratio Ra. Thus, as illustrated in FIG. 8, the index Ei increases with increasing the ratio Ra. As is clear from the results illustrated in FIG. 8, the ratio Ra is preferably 0.25 or more and 0.58 or less (i.e., from 0.25 to 0.58) as the range in which the inductor 1 is usable for a power inductor of a DC-DC converter circuit and in which the mechanical strength of the body 2 can achieve the practical level.

All the embodiments and modification examples described above exemplify aspects of the present disclosure and may be freely modified and applied without departing from the gist of the present disclosure. In addition, freely selected elements of the above embodiments may be combined to form another embodiment.

In addition, unless otherwise noted, directions such as a horizontal direction, an orthogonal direction, and a perpendicular direction, and various numerical values, shapes, and materials in the above embodiments include ranges that achieve operational effects similar to those of these directions, numerical values, shapes, and materials (so-called equivalent ranges).

### [Configurations Supported by Above Embodiments]

The above embodiments support the following configurations.

(Configuration 1) An inductor comprising a coil conductor including a wound portion and a pair of extended portions, the wound portion being formed by winding a rectangular conducting wire whose section orthogonal to a longitudinal direction of the conducting wire has a substantially rectangular shape, and the extended portions being extended from the wound portion; a body containing magnetic powder and a resin and containing the coil conductor; and outer electrodes formed on a surface of the body and connected to the respective extended portions. The body has two main surfaces that face each other and that cross a winding axis of the wound portion of the coil conductor. The extended portions each include an extended region extending from the wound portion to one of the main surfaces of the body, and an electrode connection region connected to a corresponding one of the outer electrodes. Also, in the electrode connection region, a side surface along a short side of the rectangular shape formed by the section orthogonal to the longitudinal direction of the conducting wire is exposed along the one of the main surfaces of the body, and the conductor of the conducting wire is connected to the outer electrode.

The inductor according to Configuration 1 can achieve good electrical characteristics with a reduced DC resistance regardless of the size of a section of the conducting wire forming the coil conductor.

(Configuration 2) The inductor according to Configuration 1, wherein an extended angle formed by a surface that is formed by a contour of the wound portion and that is closer to another of the main surfaces facing the one of the main surfaces of the body and a side surface, closer to the other of the main surfaces, of a part of the conducting wire forming the extended region is 90 degrees or less.

The inductor according to Configuration 2 can achieve good electrical characteristics with a good balance between inductance, DC bias current, and DC resistance.

(Configuration 3) The inductor according to Configuration 2, wherein the extended angle is 30 degrees or more and 90 degrees or less (i.e., from 30 degrees to 90 degrees).

The inductor according to Configuration 3 can achieve electrical characteristics suitable for a power inductor of a DC-DC converter circuit.

(Configuration 4) The inductor according to any one of Configurations 1 to 3, wherein a ratio of a length of the electrode connection region to a length of the extended portion is 0.25 or more and 0.58 or less (i.e., from 0.25 to 0.58).

The inductor according to Configuration 4 can achieve electrical characteristics suitable for a power inductor of a DC-DC converter circuit while maintaining, to the practical level, the mechanical strength of the body with a sufficient body wall thickness between an end portion of the electrode connection region and an outer surface of the body.

(Configuration 5) The inductor according to any one of Configurations 1 to 4, wherein the wound portion is formed by winding the conducting wire by alpha winding into two layers along the winding axis.

The inductor according to Configuration 5 includes the extended portions extended from the outermost circumferential portion of the wound portion and can achieve good electrical characteristics with a further reduced DC resistance.

What is claimed is:

1. An inductor comprising:
a coil conductor including a wound portion and a pair of extended portions, the wound portion being configured by winding a rectangular conducting wire whose section orthogonal to a longitudinal direction of the conducting wire has a substantially rectangular shape, and the extended portions being extended from the wound portion;
a body including magnetic powder and a resin, and including the coil conductor; and
outer electrodes on a surface of the body and connected to the respective extended portions, wherein
the body has two main surfaces that face each other and that cross a winding axis of the wound portion of the coil conductor,
the extended portions each include
an extended region extending from the wound portion to one of the main surfaces of the body, and
an electrode connection region connected to a corresponding one of the outer electrodes, and
in the electrode connection region, a side surface along a short side of the rectangular shape defined by the section orthogonal to the longitudinal direction of the conducting wire is exposed along the one of the main surfaces of the body, and the conductor of the conducting wire is connected to the outer electrode.

2. The inductor according to claim 1, wherein
an extended angle defined by a surface that is defined by a contour of the wound portion and that is closer to another of the main surfaces facing the one of the main surfaces of the body and a side surface, closer to the other of the main surfaces, of a part of the conducting wire configuring the extended region is 90 degrees or less.

3. The inductor according to claim 2, wherein
the extended angle is from 30 degrees to 90 degrees.

4. The inductor according to claim 1, wherein
a ratio of a length of the electrode connection region to a length of the extended portion is from 0.25 to 0.58.

5. The inductor according to claim 1, wherein
the wound portion is configured by alpha winding and includes two layers along the winding axis such that a wide surface of the conducting wire is parallel to the winding axis.

6. The inductor according to claim 2, wherein
a ratio of a length of the electrode connection region to a length of the extended portion is from 0.25 to 0.58.

7. The inductor according to claim 3, wherein
a ratio of a length of the electrode connection region to a length of the extended portion is from 0.25 to 0.58.

8. The inductor according to claim 2, wherein
the wound portion is configured by alpha winding and includes two layers along the winding axis such that a wide surface of the conducting wire is parallel to the winding axis.

9. The inductor according to claim 3, wherein
the wound portion is configured by alpha winding and includes two layers along the winding axis such that a wide surface of the conducting wire is parallel to the winding axis.

10. The inductor according to claim 4, wherein
the wound portion is configured by alpha winding and includes two layers along the winding axis such that a wide surface of the conducting wire is parallel to the winding axis.

11. The inductor according to claim 6, wherein
the wound portion is configured by alpha winding and includes two layers along the winding axis such that a wide surface of the conducting wire is parallel to the winding axis.

12. The inductor according to claim 7, wherein
the wound portion is configured by alpha winding and includes two layers along the winding axis such that a wide surface of the conducting wire is parallel to the winding axis.
